(19) United States
(12) Patent Application Publication
(10) Pub. No.: US 2020/0015169 A1
(43) Pub. Date: Jan. 9, 2020

(54) Enhanced Emergency Beacon Sending Procedure

(71) Applicant: Apple Inc., Cupertino, CA (US)

(72) Inventors: Anjaneyulu Maganti, Cupertino, CA (US); Dhruv Khati, San Jose, CA (US); Lydi Smaini, San Jose, CA (US); Sanjeevi Balasubramanian, San Jose, CA (US); Shiva Krishna Narra, San Jose, CA (US); Tarik Tabet, Los Gatos, CA (US); Mohit Narang, Cupertino, CA (US); Tiberiu Muresan, San Jose, CA (US)

(21) Appl. No.: 16/169,013

(22) Filed: Oct. 24, 2018

Related U.S. Application Data
(60) Provisional application No. 62/694,914, filed on Jul. 6, 2018.

(51) Int. Cl. H04W 52/02; H04W 4/90; H04W 4/70

(52) U.S. Cl. CPC H04W 52/0274; H04W 52/0235; G06F 3/016; H04W 4/70; H04W 4/90

(57) ABSTRACT

This disclosure relates to techniques and devices for implementing an emergency power save mode (EPSM) in a user equipment device (UE). A UE may enter the EPSM in response to user input. While operating in the EPSM, the UE may power down a display of the UE to preserve battery life and may broadcast an emergency beacon in response to user input to a hardware button of the UE, such as a volume button. The UE may supply sound or haptic feedback in response to broadcasting the emergency beacon.

### PRIORITY CLAIM

This application claims priority to U.S. provisional patent application Ser. No. 62/694,914, entitled “Enhanced Emergency Beacon Sending Procedure”, filed Jul. 6, 2018, which is hereby incorporated by reference in its entirety as though fully and completely set forth herein.

### TECHNICAL FIELD

The present application relates to wireless communication, including to techniques for broadcasting an emergency beacon.

### DESCRIPTION OF THE RELATED ART

Wireless communication systems are rapidly growing in usage. Further, wireless communication technology has evolved from voice-only communications to also include the transmission of data, such as Internet and multimedia content.

Mobile electronic devices may take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. These and other devices may be carried by users in remote locations and a user may desire to broadcast an emergency beacon in a location that is not covered by cellular service. To accommodate these and other concerns, improvements in the field are desired.

### SUMMARY

Embodiments are presented herein of, inter alia, systems, apparatuses, and methods for an emergency power save mode (EPSM) for broadcasting an emergency beacon in an energy efficient manner.

As noted above, the number of use cases for different classes of wireless devices with widely variable capabilities and usage expectations are growing. While many wireless communication systems primarily utilize infrastructure mode type communications, e.g., in which one or more base stations and potentially a supporting network are used as intermediaries between endpoint devices, one possible use case for wireless communication includes direct device-to-device (D2D) communications. This disclosure presents various techniques for utilizing device-to-device communications for implementing EPSM to broadcast one or more emergency beacons in an energy efficient manner.

The techniques described herein may be implemented in and/or used with a number of different types of devices, including but not limited to cellular phones, tablet computers, accessory and/or wearable computing devices, portable media players, cellular base stations and other cellular network infrastructure equipment, servers, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including an accessory device, according to some embodiments;

FIG. 2 illustrates an example wireless communication system in which two wireless devices can perform direct device-to-device communication, according to some embodiments;

FIG. 3 is a block diagram illustrating an example wireless device, according to some embodiments;

FIG. 4 is a block diagram illustrating an example base station, according to some embodiments;

FIGS. 5A-5C are graphs illustrating relative power consumption of various components of a UE while web browsing, sending an email over Global System for Mobile Communications (GSM) technology, and sending a short message service (SMS) message, respectively, according to some embodiments;

FIG. 6 is a communication flow diagram illustrating an exemplary method for implementing an emergency power save mode (EPSM) in a user equipment device (UE), according to some embodiments;

FIG. 7 is a schematic diagram illustrating a UE transitioning into the EPSM, according to some embodiments;

FIG. 8 illustrates the internal communication flow within the UE upon implementing EPSM and receiving user input to broadcast an emergency beacon, according to some embodiments; and

FIG. 9 illustrates an exemplary possible off grid radio service (OGRS) communication system, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Acronyms

The following acronyms are used in the present disclosure.

3GPP: Third Generation Partnership Project

3GPP2: Third Generation Partnership Project 2

GSM: Global System for Mobile Communications

UMTS: Universal Mobile Telecommunications System

LTE: Long Term Evolution

OGRS: Off Grid Radio Service

IoT: Internet of Things

NB: Narrowband

D2D: device-to-device

OOC: out-of-coverage

### Terminology

The following are definitions of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™ PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer system devices which performs wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” (also called “eNB”) has the full breadth of its ordinary meaning, and at least includes a wireless communication station installed at a fixed location and used to communicate as part of a wireless cellular communication system.

Link Budget Limited—includes the full breadth of its ordinary meaning, and at least includes a characteristic of a wireless device (e.g., a UE) which exhibits limited communication capabilities, or limited power, relative to a device that is not link budget limited, or relative to devices for which a radio access technology (RAT) standard has been developed. A wireless device that is link budget limited may experience relatively limited reception and/or transmission capabilities, which may be due to one or more factors such as device design, device size, battery size, antenna size or design, transmit power, receive power, current transmission medium conditions, and/or other factors. Such devices may be referred to herein as “link budget limited” (or “link budget constrained”) devices. A device may be inherently link budget limited due to its size, battery power, and/or transmit/receive power. For example, a smart watch that is communicating over LTE or LTE-A with a base station may be inherently link budget limited due to its reduced transmit/receive power and/or reduced antenna. Wearable devices, such as smart watches, are generally link budget limited devices. Alternatively, a device may not be inherently link budget limited, e.g., may have sufficient size, battery power, and/or transmit/receive power for normal communications over LTE or LTE-A, but may be temporarily link budget limited due to current communication conditions, e.g., a smart phone being at the edge of a cell, etc. It is noted that the term “link budget limited” includes or encompasses power limitations, and thus a power limited device may be considered a link budget limited device.

Processing Element (or Processor)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

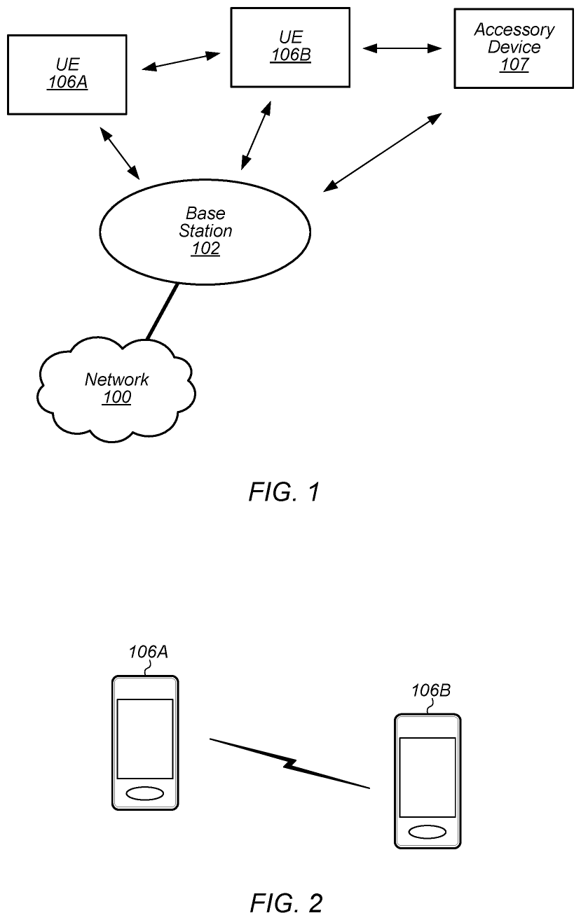

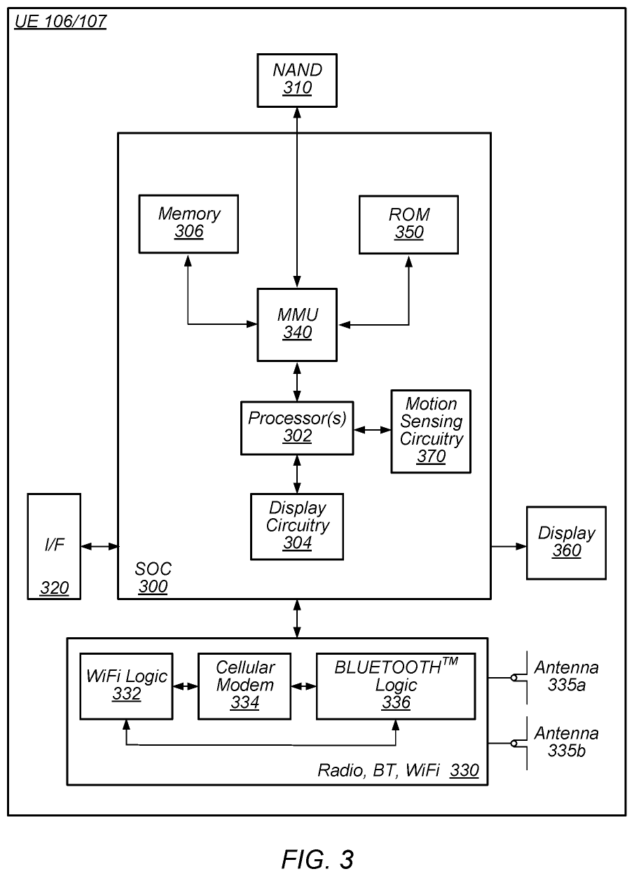

### FIGS. 1-2—Wireless Communication System

FIG. 1 illustrates an example of a wireless cellular communication system. It is noted that FIG. 1 represents one possibility among many, and that features of the present disclosure may be implemented in any of various systems, as desired. For example, embodiments described herein may be implemented in any type of wireless device.

As shown, the exemplary wireless communication system includes a cellular base station 102, which communicates over a transmission medium with one or more wireless devices 106A, 106B, etc., as well as accessory device 107. Wireless devices 106A, 106B, and 107 may be user devices, which may be referred to herein as “user equipment” (UE) or UE devices.

The base station 102 may be a base transceiver station (BTS) or cell site, and may include hardware that enables wireless communication with the UE devices 106A, 106B, and 107. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the UE devices 106 and 107 and/or between the UE devices 106/107 and the network 100. In other implementations, base station 102 can be configured to provide communications over one or more other wireless technologies, such as an access point supporting one or more WLAN protocols, such as 802.11 a, b, g, n, ac, ad, and/or ax, or LTE in an unlicensed band (LAA).

The communication area (or coverage area) of the base station 102 may be referred to as a “cell.” The base station 102 and the UEs 106/107 may be configured to communicate over the transmission medium using any of various radio access technologies (RATs) or wireless communication technologies, such as GSM, UMTS (WCDMA, TDS-CDMA), LTE, LTE-Advanced (LTE-A), NR, OGRS, HSPA, 3GPP2 CDMA2000 (e.g., 1×RTT, 1×EV-DO, HRPD, eHRPD), Wi-Fi, etc.

Base station 102 and other similar base stations (not shown) operating according to one or more cellular communication technologies may thus be provided as a network of cells, which may provide continuous or nearly continuous overlapping service to UE devices 106A-B and 107 and similar devices over a geographic area via one or more cellular communication technologies.

Note that at least in some instances a UE device 106/107 may be capable of communicating using any of multiple wireless communication technologies. For example, a UE device 106/107 might be configured to communicate using one or more of GSM, UMTS, CDMA2000, LTE, LTE-A, NR, OGRS, WLAN, Bluetooth, one or more global navigational satellite systems (GNSS, e.g., GPS or GLONASS), one and/or more mobile television broadcasting standards (e.g., ATSC-M/H), etc. Other combinations of wireless communication technologies (including more than two wireless communication technologies) are also possible. Likewise, in some instances a UE device 106/107 may be configured to communicate using only a single wireless communication technology.

The UEs 106A and 106B may include handheld devices such as smart phones or tablets, and/or may include any of various types of device with cellular communications capability. For example, one or more of the UEs 106A and 106B may be a wireless device intended for stationary or nomadic deployment such as an appliance, measurement device, control device, etc. The UE 106B may be configured to communicate with the UE device 107, which may be referred to as an accessory device 107. The accessory device 107 may be any of various types of wireless devices, typically a wearable device that has a smaller form factor, and may have limited battery, output power and/or communications abilities relative to UEs 106. As one common example, the UE 106B may be a smart phone carried by a user, and the accessory device 107 may be a smart watch worn by that same user. The UE 106B and the accessory device 107 may communicate using any of various short range communication protocols, such as Bluetooth or Wi-Fi, in addition to long range communication protocols, such as cellular communications.

The UE 106B may also be configured to communicate with the UE 106A. For example, the UE 106A and UE 106B may be capable of performing direct device-to-device (D2D) communication. The D2D communication may be supported by the cellular base station 102 (e.g., the BS 102 may facilitate discovery, among various possible forms of assistance), or may be performed in a manner unsupported by the BS 102. For example, according to at least some aspects of this disclosure, the UE 106A and UE 106B may be capable of arranging and performing narrowband D2D communication with each other, such as broadcasting emergency beacons, even when out-of-coverage of the BS 102 and other cellular base stations.

FIG. 2 illustrates example UE devices 106A, 106B in D2D communication with each other. The UE devices 106A, 106B may be any of a mobile phone, a tablet, or any other type of hand-held device, a smart watch or other wearable device, a media player, a computer, a laptop or virtually any type of wireless device.

The UEs 106A, 106B may each include a device or integrated circuit for facilitating cellular communication, referred to as a cellular modem. The cellular modem may include one or more processors (processing elements) and various hardware components as described herein. The UEs 106A, 106B may each perform any of the method embodiments described herein by executing instructions on one or more programmable processors. Alternatively, or in addition, the one or more processors may be one or more programmable hardware elements such as an FPGA (field-programmable gate array), or other circuitry, that is configured to perform any of the method embodiments described herein, or any portion of any of the method embodiments described herein. The cellular modem described herein may be used in a UE device as defined herein, a wireless device as defined herein, or a communication device as defined herein. The cellular modem described herein may also be used in a base station or other similar network side device.

The UEs 106A, 106B may include one or more antennas for communicating using two or more wireless communication protocols or radio access technologies. In some embodiments, one or both of the UE 106A or UE 106B might be configured to communicate using a single shared radio. The shared radio may couple to a single antenna, or may couple to multiple antennas (e.g., for MIMO) for performing wireless communications. Alternatively, the UE 106A and/or UE 106B may include two or more radios. Other configurations are also possible.

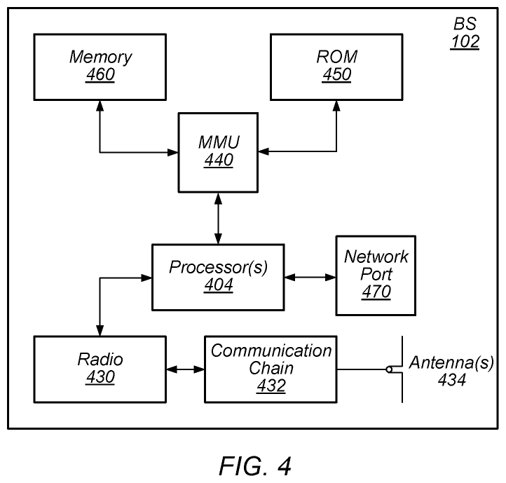

### FIG. 3—Block Diagram of a UE Device

FIG. 3 illustrates one possible block diagram of an UE device, such as UE device 106 or 107. As shown, the UE device 106/107 may include a system on chip (SOC) 300, which may include portions for various purposes. For example, as shown, the SOC 300 may include processor(s) 302 which may execute program instructions for the UE device 106/107, and display circuitry 304 which may perform graphics processing and provide display signals to the display 360. The SOC 300 may also include motion sensing circuitry 370 which may detect motion of the UE 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, flash memory 310). The MMU 340 may be configured to perform memory protection and page table translation or set up. In some embodiments, the MMU 340 may be included as a portion of the processor(s) 302.

As shown, the SOC 300 may be coupled to various other circuits of the UE 106/107. For example, the UE 106/107 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, OGRS, CDMA2000, Bluetooth, Wi-Fi, NFC, GPS, etc.).

The UE device 106/107 may include at least one antenna, and in some embodiments multiple antennas 335a and 335b, for performing wireless communication with base stations and/or other devices. For example, the UE device 106/107 may use antennas 335a and 335b to perform the wireless communication. As noted above, the UE device 106/107 may in some embodiments be configured to communicate wirelessly using a plurality of wireless communication standards or radio access technologies (RATs).

The wireless communication circuitry 330 may include Wi-Fi Logic 332, a Cellular Modem 334, and Bluetooth Logic 336. The Wi-Fi Logic 332 is for enabling the UE device 106/107 to perform Wi-Fi communications on an 802.11 network. The Bluetooth Logic 336 is for enabling the UE device 106/107 to perform Bluetooth communications. The cellular modem 334 may be a lower power cellular modem capable of performing cellular communication according to one or more cellular communication technologies.

As described herein, UE 106/107 may include hardware and software components for implementing embodiments of this disclosure. For example, one or more components of the wireless communication circuitry 330 (e.g., cellular modem 334) of the UE device 106/107 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

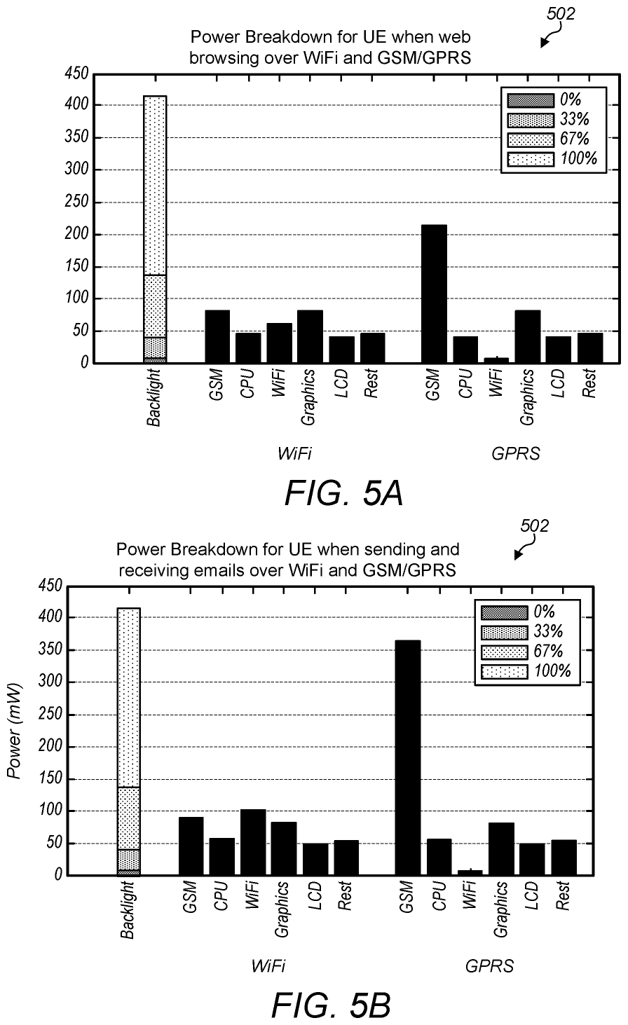

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106/107, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106/107. For example, the core network may include a mobility management entity (MME), e.g., for providing mobility management services, a serving gateway (SGW) and/or packet data network gateway (PGW), e.g., for providing external data connections such as to the Internet, etc. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106/107 via radio 430. The antenna(s) 434 communicates with the radio 430 via communication chain 432. Communication chain 432 may be a receive chain, a transmit chain or both. The radio 430 may be configured to communicate via various wireless communication standards, including, but not limited to, LTE, LTE-A, NR, OGRS, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a Wi-Fi radio for performing communication according to Wi-Fi. In such a case, the base station 102 may be capable of operating as both an LTE base station and a Wi-Fi access point. As another possibility, the base station 102 may include a multi-mode radio which is capable of performing communications according to any of multiple wireless communication technologies (e.g., LTE and Wi-Fi, LTE and UMTS, LTE and CDMA2000, UMTS and GSM, etc.).

As described further subsequently herein, the BS 102 may include hardware and software components for implementing or supporting implementation of features described herein. For example, while many of the features described herein relate to device-to-device communication that can be performed by UE devices without relying on an intermediary base station, a cellular base station may be configured to also be capable of performing device-to-device communication in accordance with the features described herein. As another possibility, the BS 102 may be instrumental in configuring a UE 106 to perform narrowband device-to-device communication according to the features described herein, and/or certain features described herein may be performed or not performed by a device based at least in part on whether there is a BS 102 providing cellular service within range of the device. According to some embodiments, the processor 404 of the base station 102 may be configured to implement part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

### Enhanced Emergency Beacon Sending Procedure

In some embodiments, a UE may be configured to implement an emergency beacon broadcast feature, whereby the UE may be configured to broadcast an emergency beacon in response to user input. For example, a user may become lost or injured while hiking and may use an emergency beacon broadcast feature to notify other users or base stations in the area. While embodiments herein are described in terms of emergency beacon broadcasting, the methods described may be broadly applied to any type of beacon broadcast, according to various embodiments. For example, a UE in a crowded stadium or other environment may be unable to camp on a base station because of cellular congestion, and it may be desirable for the UE to implement power-efficient beacon broadcasting according to methods described herein. In some embodiments, and as described in greater detail below, the emergency beacon broadcast feature may operate as an off-grid radio service (OGRS) when the UE does not have an active connection to a base station or other wireless access point.

If a user of a UE is in a dire situation or another situation that would benefit from emergency beacon broadcasting or beacon broadcasting in general, a significant amount of time may pass before a broadcast emergency beacon is successfully received by another user or a base station and help is mobilized to assist the user. For example, a user in a remote rural location may not be within a communicatively effective distance from other UEs or base stations capable of receiving the emergency beacon. As such, it may be desirable for the UE to be able to broadcast emergency beacons over an extended period of time, to increase the likelihood of a successful reception of the broadcast. Furthermore, because a user in such a situation may likely not have access to a power source to recharge the battery of the UE, a rapidly draining battery life of the UE may reduce duration that the UE is capable of broadcasting. This may potentially reduce the chance that the emergency beacon is successfully broadcast and received before the battery is drained.

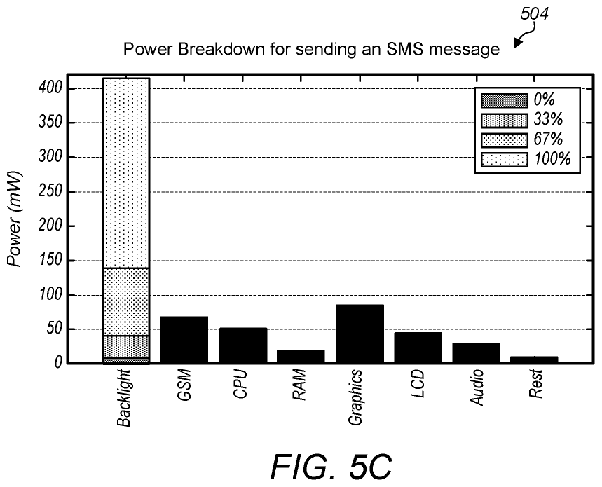

Embodiments described herein describe methods and devices configured to implement an algorithm for an Emergency Power Save Mode (EPSM) which may preserve battery while enabling emergency beacon broadcasting through efficient handling of the display of the device and radio frequency (RF) signaling. As illustrated in FIGS. 5A-5C, which were taken from An Analysis of Power Consumption in a Smartphone from USENIX, the display backlight may consume a large portion of the battery life of a UE device. FIG. 5A compares the power consumption of the display backlight at 0%, 33%, 67% and 100% brightness to the power consumption of each of various other processes operating in the UE while the UE is performing web browsing over WiFi and Global System for Mobile communication (GSM) general packet radio service (GPRS) technology. FIG. 5A separates out the power consumption of the WiFi and GPRS components of the UE. As illustrated, at 100% brightness the backlight uses more power than any other component during web browsing.

FIG. 5B is a similar graph illustrating the breakdown of power consumption for various component of a UE while the UE is sending and receiving emails using WiFi and GSM GPRS technology. FIG. 5B separates out the power consumption of WiFi components and GPRS components of the UE. As illustrated, while the GSM GPRS component consumes a large proportion of the UE's power expenditure (approximately 360 mW in FIG. 5B), the backlight of the UE consumes even more power (approximately 410 mW) at 100% brightness. Thus, while utilizing a GSM radio for transmission, the backlight and RF signaling may result in the two dominant sources of power drain for the UE. A typical implementation of emergency beacon broadcasting (i.e., without EPSM) may have a similar power consumption profile to 5A and 5B, as a user may typically require the backlight to be active to broadcast an emergency beacon.

FIG. 5C is a similar graph illustrating the breakdown of power consumption for various components of a UE while the UE is sending a short message service (SMS) message (i.e., a text messages). As illustrated, at 66% or higher brightness, the backlight is the largest drain on the battery for regular UE usage. Even more, at 100% brightness the backlight alone uses more power than all other components combined while sending an SMS message.

Because the backlight of the UE and RF signaling by the UE consume a large proportion of the battery of the UE, the chance that an emergency beacon is successful may be improved by implementing an Emergency Power Save Mode (EPSM), as described herein, to extend the battery life of the UE while enabling emergency beacon broadcasting, and to thereby extend the amount of time in which the UE can broadcast emergency beacons without recharging the battery.

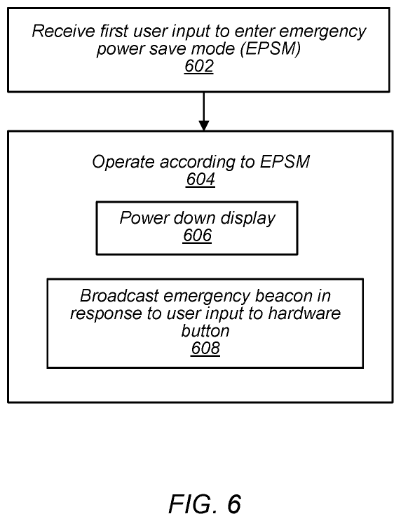

### FIG. 6—Emergency Power Save Mode Flow Diagram

FIG. 6 is a communication flow diagram illustrating a method for implementing EPSM, according to some embodiments. In various embodiments, some of the elements of the methods shown may be performed concurrently, in a different order than shown, may be substituted for by other method elements, or may be omitted. Additional method elements may also be performed as desired.

Aspects of the method of FIG. 6 may be implemented by a wireless device, such as the UEs 106A-B or 107 illustrated in and described with respect to FIGS. 1-3, or more generally in conjunction with any of the computer systems or devices shown in the above Figures, among other devices, as desired. Note that while at least some elements of the method of FIG. 6 are described in a manner relating to the use of communication techniques and/or features associated with LTE, 5G NR, OGRS, and/or 3GPP specification documents, such description is not intended to be limiting to the disclosure, and aspects of the method of FIG. 6 may be used in any suitable wireless communication system, as desired. As shown, the method may operate as follows.

At 602, first user input may be received, causing the UE to enter an emergency power save mode (EPSM). For example, a user may encounter an emergency and may desire to broadcast emergency beacons (potentially over an extended period of time) while preserving battery life as much as possible. Alternatively, the user may desire to broadcast another type of beacon for an extended period of time and may present first user input to the UE to enter the EPSM for efficient broadcasting power consumption. In some embodiments, the user may navigate a user interface of the UE and manually activate EPSM. For example, a user may input the first user input using a touch screen of the UE to select the EPSM. Alternatively or additionally, the UE may be configured to automatically display an icon on a display of the UE in response to one or more factors, e.g., upon determining EPSM may be advantageous or desired. For example, the UE may determine that the remaining battery level of the UE is below a predetermined threshold (e.g., below 10% remaining or another threshold), and in response, the UE may automatically display an icon on the display that is configured to receive user input to cause the UE to enter the EPSM. In some embodiments the predetermined threshold may be configurable by the user.

As another possibility, a user may select an option to enable a potential future transition to the EPSM based on the battery threshold. For example, if a user is embarking on a hiking expedition or otherwise anticipating an absence of cellular service, he or she may select an option for the UE to enter a “provisional EPSM” whereby the UE will automatically enter the EPSM when the remaining battery life of the UE falls below the predetermined threshold (e.g., so that the battery is less likely to become completely drained during the hike, in case an accident occurs and an emergency beacon broadcast would be desirable). In this embodiment, the first user input selecting the provisional EPSM may cause the UE to enter the EPSM after one or more additional conditions are met (e.g., after the UE additionally determines that the battery level has fallen below a predetermined threshold). Upon returning from the hike, the user may then select to deactivate the provisional EPSM mode.

At 604, the UE may operate according to the EPSM. While in the EPSM, the UE may be configured to power down the display of the UE (606). Powering down the display may preserve the battery life of the UE, while still enabling the UE to broadcast emergency beacons. In other words, the UE may be configured to broadcast an emergency beacon even with the display powered off. For example, while in the EPSM, the UE may be further configured to broadcast an emergency beacon using the radio in response to receiving second user input (608). For example, while in the EPSM, the UE may be configured to broadcast an emergency beacon (or a group of emergency beacons) in response to the user pressing a hardware button of the UE (e.g., a volume up button, a volume down button, or a power button, among other possibilities). More broadly, the second user input may involve activating, switching or pressing any of a variety of physical buttons, hardware buttons or switches on the UE. Importantly, the second user input may be received without utilizing the touch screen of the UE, since the display of the UE is powered off and the touch screen may not be available to receive user input in EPSM.

The UE may be configured to repeatedly broadcast an emergency beacon (or group of emergency beacons) each time the user presses the designated hardware button. As one example, a user may desire to wait until he or she reaches a high point of elevation with a clear view of the surrounding area, or another desirable broadcasting location, before pressing the hardware button. Enabling the user to selectively determine when an emergency beacon is broadcast may preserve battery life (e.g., by only broadcasting the beacon in response to user input, rather than periodically broadcasting the beacon). User-selective beacon broadcasting may potentially increase the chances of the broadcast being successfully received, as the user may select to broadcast the beacon only when the UE is located in a desirable broadcasting location (i.e., a location with a higher probability of being successfully received). In contrast, if the emergency beacon is automatically periodically broadcasted, energy may be unnecessarily drained if the beacon is broadcasted when the UE is in a poor broadcasting location (e.g., underground, in dense forest, or another poor location).

However, it should be noted that automatic broadcasting could still be enabled or invoked, if desired. For example, if the user is losing consciousness or would otherwise prefer automatic periodic broadcasting of the emergency beacon, he may initiate an automatic broadcasting mode. In this mode, the UE may simply automatically broadcast the emergency beacon at a pre-determined interval. Alternatively, in this automatic mode, the UE may be configured to modify or vary the interval between beacons, e.g., based on cell conditions, detection of nearby devices or signals, the battery level of the UE, etc.

In some embodiments, the emergency beacon may be an off-grid radio service (OGRS) device-to-device (D2D) communication. For example, the UE may broadcast an emergency beacon according to existing D2D communication protocols. The emergency beacon may include identification information of the broadcasting UE and/or the user of the UE, as desired. If the UE is equipped with a global navigational satellite systems (GNSS, e.g., GPS or GLONASS) capability, or if the UE is otherwise aware of its location, the emergency beacon may additionally include location information of the UE obtained through the GNSS or otherwise obtained. The emergency beacon may be receivable by other UEs and/or by base stations. In some embodiments, a second UE that receives an emergency beacon broadcast from a first UE may be configured to automatically forward the beacon to a base station, or, if the second UE receiving the broadcast is not in connection with or camped on a base station, the second UE may automatically rebroadcast the emergency beacon to be received by a third UE. When the emergency beacon is successfully received by a base station or another network entity, the emergency beacon may be forwarded to an emergency service (e.g., 911, park rescue, or another emergency service) to potentially initiate a rescue or assistance effort for the user of the first UE.

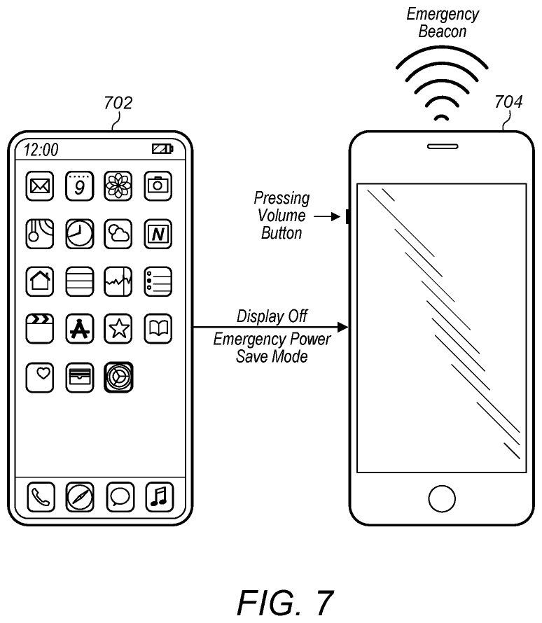

FIG. 7 is a schematic diagram illustrating a UE that transitions from operating normally (702) to operating according to the EPSM (704). As illustrated, transitioning to the EPSM causes the UE to power off the display. Additionally, pressing the volume button (or another hardware button, as desired) may trigger the UE to broadcast an emergency beacon (or a plurality of emergency beacons, as desired), as illustrated.

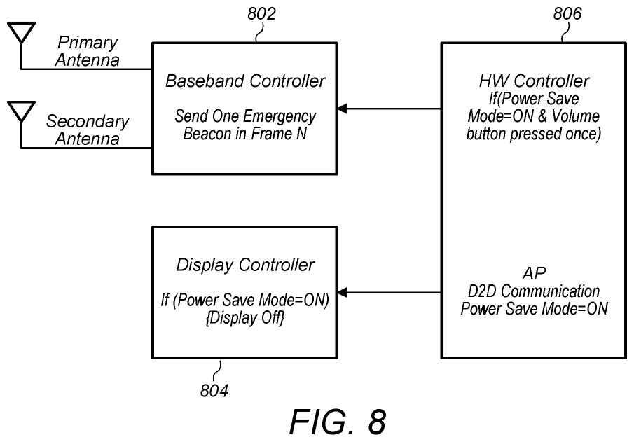

FIG. 8 illustrates the internal communication flow within the UE upon implementing EPSM and receiving user input to broadcast an emergency beacon. As illustrated, if an application processor (AP, e.g., the processor(s) 302 illustrated in FIG. 3) of the UE is configured with D2D communications and the EPSM is set to ON, the AP may notify a display controller 804 (e.g., the display controller may be substantially similar to the display circuitry illustrated in FIG. 3) of the UE to turn the display off. Additionally, if the UE is operating in the EPSM and a volume button is pressed once, the hardware (HW) controller may notify the baseband controller 802 to send one emergency beacon in a particular frame N using either of a primary antenna or a secondary antenna. As noted above, in other embodiments, more than one emergency beacon could be transmitted in response to a single volume (or other hardware) button press.

In some embodiments, the UE may provide haptic motion feedback or emit a sound in response to broadcasting the emergency beacon. For example, because the display of the UE is powered off while operating in EPSM, the user may be otherwise unable to determine whether the emergency beacon was successfully broadcasted, or if the UE battery has died. A user operating in EPSM may be in a stressful and potentially life-threatening situation, and haptic motion feedback and/or a sound emission by the UE may notify and reassure the user that the emergency beacon was broadcast.

Embodiments described herein may be employed for situations other than a user of a UE in a remote location. For example, a user may be in a location such as a stadium or concert that is overly congested with cellular devices such that the user may have difficulty establishing a cellular connection. In these or similar situations, it may be desirable for the UE to enter the EPSM to broadcast emergency beacons or other types of beacons in a power efficient manner without having to establish a connection with a cell or base station.

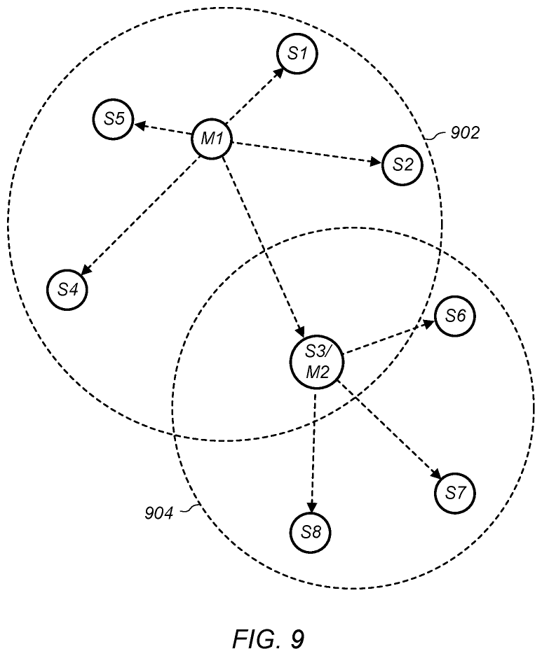

### FIG. 9 and Additional Information—Off Grid Radio Service

Off Grid Radio Service (OGRS) is a system to provide long range peer-to-peer (P2P)/D2D communication, e.g., in absence of a wide area network (WAN) or WLAN radio connection to support a variety of possible features. At least according to some embodiments, OGRS systems may support some or all of the features previously described herein, such as any of the features or steps of the method of implementing EPMS as described in association with FIG. 6. FIG. 9 and the following additional information are provided as being illustrative of a variety of further possible features and details of a possible OGRS communication system, and are not intended to be limiting to the disclosure as a whole. Numerous variations and alternatives to the details provided herein below are possible and should be considered within the scope of the disclosure.

According to some embodiments, OGRS may operate in unlicensed low ISM bands, e.g., between 700 MHz and 1 GHz, for extended range purposes, and may use one or multiple carriers of approximately 200 kHz. OGRS may be designed to meet the local spectrum regulatory requirements, such as channel duty cycle, operating frequencies, hopping pattern, listen-before-talk (LBT), maximum transmit power, and occupied bandwidth.

Any of a variety of features may be included in an OGRS system, including when operating in regulated unlicensed spectrum, such as 900 MHz unlicensed spectrum. For example, frequency hopping spread spectrum (FHSS) may be used. Channel carrier frequencies may be separated by a minimum of 25 kHz, or the 20 dB bandwidth of the hopping channel, whichever is the greater. Channel hopping frequencies may be selected at the system, and/or the hopping rate may be pseudo-random in nature. On average, each channel hopping frequency may be used equally. The receiver bandwidth may match that of the transmitter and may hop in synchronization with the transmitter. A maximum 20 dB bandwidth of the hopping channel may be 500 kHz. If the 20 dB bandwidth is less than 250 kHz, the system may use at least 50 channels. In this case, the average dwell time on a particular channel may not exceed 400 ms within a 20 second period, and/or transmit power may be limited to 30 dBm. If the 20 dB bandwidth is 250 kHz or greater, then the system may use at least 25 channels. In this case, the average dwell time may not exceed 400 ms within a 10 second period, and/or transmit power may be limited to 24 dBm. For example, the following table illustrates a possible set of specified features for OGRS operation depending on the 20 dB bandwidth of the hopping channels used:

| BW | #Channel | TX Power | On Time | Dwell Time |
|---|---|---|---|---|
| <250 KHz | >=50 | 30 dBm | 400 ms | 20 sec |
| >250 KHz | <=25 | 24 dBm | 400 ms | 10 sec |

FIG. 9 illustrates aspects of an exemplary possible OGRS communication system, according to some embodiments. As shown, the system may include a first OGRS group 902 and a second OGRS group 904. In a given environment, an OGRS group may operate independently, or multiple OGRS groups may co-exist, e.g., as illustrated in FIG. 9. Each of the groups may have a group master and group members; for example, the first OGRS group 902 may include a ‘master’ Ml, along with several ‘slaves’ S1, S2, S3, S4, S5. A master in a group may transmit synchronization channels to which other members in the group, and any devices that wish to join the group, may obtain synchronization from the synchronization signals provided by the master. For example, the synchronization channel(s) may assist with bringing all the members in the group to a common frequency and time and may be helpful for the nodes in the group for later communication.

A further exemplary set of embodiments may include an apparatus, comprising a processing element configured to cause a device to implement any or all parts of the preceding examples.

Another exemplary set of embodiments may include a wireless device, comprising: an antenna; a radio coupled to the antenna; and a processing element operably coupled to the radio, wherein the device is configured to implement any or all parts of the preceding examples.

A yet further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

As described above, one aspect of the present technology is an energy efficient method of broadcasting emergency beacons or other types of beacons. The present disclosure contemplates that in some instances, the emergency beacon may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used increase the effectiveness of the beacon. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of emergency beacon broadcasting, the present technology can be configured to allow users to select to “opt in” or “opt out” of participation in the broadcasting of personal information data during EPSM or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, emergency or other beacons may be broadcast based on non-personal information data or a bare minimum amount of personal information, such as other non-personal information available to the content delivery services, or publicly available information.

In addition to the above-described exemplary embodiments, further embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106 or 107) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A user equipment device (UE), comprising:
a display;
an antenna;
a radio operably coupled to the antenna; and
a processing element coupled to the radio and the display, wherein the UE is configured to:
receive first user input causing the UE to enter an emergency power save mode (EPSM);
wherein, while in the EPSM, the UE is configured to:
power down the display; and
broadcast an emergency beacon using the radio in response to receiving second user input.

2. The UE of claim 1, wherein the UE is further configured to:
determine that a remaining battery level of the UE is below a predetermined threshold; and
in response to determining that the remaining battery level of the UE is below the predetermined threshold, automatically display an icon on the display that is configured to receive the first user input to cause the UE to enter the EPSM.

3. The UE of claim 1,
wherein the emergency beacon comprises an off-grid radio service (OGRS) device-to-device communication.

4. The UE of claim 1, wherein the UE is further configured to:
provide haptic feedback in response to successfully broadcasting the emergency beacon.

5. The UE of claim 1, wherein the UE is further configured to:
emit a sound in response to successfully broadcasting the emergency beacon.

6. The UE of claim 1, wherein the second user input comprises pressing a hardware button of the UE.

7. The UE of claim 6, wherein the hardware button is a volume button.

8. A method for implementing an emergency power save mode, the method comprising, by a user equipment device (UE):
receiving first user input causing the UE to enter the emergency power save mode (EPSM); and
while in the EPSM:
powering down a display of the UE; and
broadcasting an emergency beacon using a radio of the UE in response to receiving second user input.

9. The method of claim 8, the method further comprising:
determining that a remaining battery level of the UE is below a predetermined threshold; and
in response to determining that the remaining battery level of the UE is below the predetermined threshold, automatically displaying an icon on the display that is configured to receive the first user input to cause the UE to enter the EPSM.

10. The method of claim 8,
wherein the emergency beacon comprises an off-grid radio service (OGRS) device-to-device communication.

11. The method of claim 8, the method further comprising:
providing haptic feedback in response to successfully broadcasting the emergency beacon.

12. The method of claim 8, the method further comprising:
emitting a sound in response to successfully broadcasting the emergency beacon.

13. The method of claim 8, wherein the second user input comprises pressing a hardware button of the UE.

14. The method of claim 13, wherein the hardware button is a volume button.

15. An apparatus comprising a processing element and configured to cause a UE to:
in response to receiving first user input, cause the UE to enter an emergency power save mode (EPSM); and
while in the EPSM:
power down a display of the UE; and
broadcast an emergency beacon using a radio of the UE in response to receiving second user input.

16. The apparatus of claim 15, wherein the apparatus is further configured to cause the UE to:
determine that a remaining battery level of the UE is below a predetermined threshold; and
in response to determining that the remaining battery level of the UE is below the predetermined threshold, automatically display an icon on the display that is configured to receive the first user input to cause the UE to enter the EPSM.

17. The apparatus of claim 15,
wherein the emergency beacon comprises an off-grid radio service (OGRS) device-to-device communication.

18. The apparatus of claim 15, wherein the apparatus is further configured to cause the UE to:
provide haptic feedback in response to successfully broadcasting the emergency beacon.

19. The apparatus of claim 15, wherein the apparatus is further configured to cause the UE to:
emit a sound in response to successfully broadcasting the emergency beacon.

20. The apparatus of claim 15, wherein the second user input comprises activating a physical button of the UE.
